(19) United States
(12) Patent Application Publication
(10) Pub. No.: US 2010/0086145 A1
(43) Pub. Date: Apr. 8, 2010

(54) THIN LOUDSPEAKER SYSTEM WITH SEPARATE CONTOURED PASSIVE RADIATOR USING TRANSMISSION LINE

(75) Inventors: J. Dwidjaja Setiabudi, Kudus (ID); Adisusanto, Kudus (ID); Setiawan Yusran, Kudus (ID); Hadi Prajitno, Kudus (ID); Nafis Dwi Cahyo, Kudus (ID); Bismo Ragil Saputro, Kudus (ID); Fx Darmojo Sakti, Kudus (ID); Ahmad Sugiharto, Kudus (ID); Heru Mulyatmo, Kudus (ID)

Correspondence Address: ROTHWELL, FIGG, ERNST & MANBECK, P.C., 1425 K STREET, N.W., SUITE 800, WASHINGTON, DC, 20005, US

(73) Assignee: PT. HARTONO ISTANA TEKNOLOGI, Kudus (ID)

(21) Appl. No.: 12/244,600

(22) Filed: Oct. 2, 2008

(51) Int. Cl. H04B 1/00; H04R 1/02; H04R 1/20

(52) U.S. Cl. 381/86; 381/394; 381/388; 381/349

(57) ABSTRACT

A thin loudspeaker system has at least one contoured passive radiator enclosure outside the main unit, connected with at least one loudspeaker enclosure inside the main unit through at least one transmission line. The transmission line cross-sectional shape may be a circular, rounded rectangular, ovular, elliptical or any other suitable shape. With this method the diaphragm size of the contoured passive radiator may be as large as possible, without changing the thickness of main unit. The larger-sized passive radiator diaphragm may increase the air movement and as a result may increase sound pressure level (SPL) at low frequencies. This system may reduce the thickness of audio video equipment significantly and may be useful for producing deeper bass at low frequencies with less distortion, for thin equipment such as LCD TVs, plasma TVs, thin audio hi-fi system, car loudspeaker system, and other similar systems. For a full range loudspeaker system, a mid-high loudspeaker with an appropriate enclosure may be installed, whether in the contoured passive radiator enclosure or in the main unit.

### TECHNICAL FIELD

The present disclosure is in the field of electro acoustic audio equipment, specifically for a loudspeaker with a separate contoured passive radiator.

### BACKGROUND

Present audio video equipment typically requires good sound quality, clear vocal, transparent treble and deep bass frequency.

To produce deep bass frequency sound, a sub woofer system is typically used. The bigger the enclosure volume, the higher the bass sound pressure level can get. Meanwhile, the tendencies of audio video equipment is to become thinner, for example plasma televisions (TVs), liquid crystal display (LCD) TVs, even cathode ray tube (CRT) TVs have become slimmer. This results in the enclosure volume becoming smaller and as a result less able to produce optimal bass sound.

In an LCD TV system application, a loudspeaker enclosure E is attached at the bottom side of the LCD screen (FIG. 1a) or on the left and right side of the LCD screen (FIG. 1b). For aesthetic purposes, the frame of the LCD screen is typically made as thin as possible. So typically the only space for a loudspeaker system is at bottom (FIG. 1c), and typically with a smaller enclosure too. Meanwhile, it is typically difficult to affix a loudspeaker enclosure at the LCD backside because electronic circuitry is located there. As a result, there is a need for a LCD TV with an aesthetically-pleasing thin frame and with a good low frequency deep bass sound.

Other systems, such as that disclosed in U.S. App. Pub. No. 2007/0058830 A1 titled “Contoured Passive Radiator and Loudspeaker Incorporating Same”, have the advantage of being able to produce a higher sound pressure level (SPL) at low frequencies, with less distortion in a small enclosure size, especially when it has an arcuate contour. But referring to FIG. 2, having an assembly with both a low frequency loudspeaker 2p (where d denotes its diameter) and a contoured passive radiator 1p in an enclosure 3p means that there is a minimum depth d1 for the enclosure. For example, when using a 4-inch loudspeaker driver (i.e., d is 4 inches), the depth d1 of loudspeaker box would be at least 4.5 inches, where the extra thickness is due to the thickness of the plastic wall and mounting. When implementing this design for a plasma TV or a LCD TV, this limit may not be suitable.

A thin loudspeaker system has been discussed by Sakamoto in U.S. Pat. No. 5,668,886 and Kohara in U.S. Pat. No. 5,511,131. Both disclose a loudspeaker structure that can reduce the thickness of a loudspeaker without reducing the performance quality. However, these still do not address all the features and advantages of the present disclosure.

### SUMMARY

The present disclosure addresses at least some of the challenges discussed above. The present disclosure provides a contoured passive radiator and a loudspeaker system incorporating the same.

The contoured passive radiator is separated from the loudspeaker enclosure. The passive radiator enclosure is placed outside the main unit, and connects with the loudspeaker enclosure inside the main unit through at least one transmission line. The transmission line cross-sectional shape may be circular, rounded rectangular, ovular, elliptical or any other suitable shape to achieve the desired result. With this method the diaphragm size of the contoured passive radiator may be as large as possible, without changing the thickness of the main unit. The larger passive radiator diaphragm may increase the air movement and as a result increase sound pressure level (SPL) at low frequencies. The system of this disclosure may reduce the thickness of audio-video equipment significantly and may be useful for producing deeper bass at low frequencies with less distortion, for thin equipment such as a LCD TV, a plasma TV, a thin audio hi-fi system, a car loudspeaker system, a figure loudspeaker, and other similar equipment. For a full range loudspeaker system, a mid-high loudspeaker with an appropriate enclosure may be installed, whether in the contoured passive radiator enclosure or in the main unit.

In some aspects, there is provided a thin loudspeaker system for audio video equipment, comprising: at least one loudspeaker enclosure having at least one loudspeaker driver placed inside a main unit; at least one contoured passive radiator enclosure having at least one passive radiator diaphragm separate from the loudspeaker enclosure, outside the main unit; and at least one transmission line for connecting the contoured passive radiator enclosure to the loudspeaker enclosure. Since passive radiator loudspeaker systems are typically an improvement over conventional bass reflex systems, this system may have less distortion since this system does not produce the turbulent sound that is generated due to the port of the bass reflex system radiating reflected sound from inside the enclosure.

In some aspects, there is provided a thin loudspeaker system for a thin television such as an LCD TV or a plasma TV. The contoured passive radiator enclosure described above may also act as a stand for supporting the TV, for example an LCD panel. The passive radiator diaphragm may be placed at the bottom side of the stand, while at the upper side of the stand there may be a hollow structure made from, for example, a metal material surrounded with a plastic material. Inside the hollow structure there is a transmission line which connects the passive radiator enclosure and the loudspeaker enclosure. The loudspeaker enclosure may be placed inside the main unit, at the back side of the LCD panel. Using this system, although the thickness of the LCD TV is relatively thin, it may produce a high bass sound pressure level without producing sound distortion due to turbulent sound at the port.

In some aspects, there is provided a loudspeaker system for audio equipment comprising: at least one loudspeaker enclosure having at least one loudspeaker driver placed inside a main unit; a pair of thin contoured passive radiator enclosures each having a passive radiator diaphragm separate from a loudspeaker enclosure, the enclosures being located at the left and right sides of the main unit; and a transmission line for connecting each contoured passive radiator enclosure to the loudspeaker enclosure.

In some aspects, there is provided a loudspeaker system for car audio equipment comprising: a low frequency loudspeaker enclosure having at least one loudspeaker driver, placed inside the main unit, located between front chairs of a car; at least two contoured passive radiator enclosures; and a transmission line that connects the loudspeaker enclosure to the at least two passive radiator enclosures.

In some aspects, there is provided a method of increasing the bass frequency sound pressure level of a thin loudspeaker system, comprising: providing at least one loudspeaker enclosure having at least one loudspeaker driver mounted therein, the loudspeaker enclosure being inside a main unit; providing at least one contoured passive radiator enclosure having at least one passive radiator diaphragm separate from the loudspeaker enclosure, outside the main unit; providing at least one transmission line for mounting the passive radiator enclosure outside the main unit; and passing a bass signal through the loudspeaker driver whereby the sound pressure level of the output of the loudspeaker driver is increased.

Reference will now be made to the accompanying drawings.

### BRIEF DESCRIPTION OF THE DRAWINGS

FIG. 1 illustrates a prior art system that places a loudspeaker at the bottom of the LCD panel (FIG. 1a), at the left and right sides of the LCD panel (FIG. 1b) and below the LCD panel facing downwards (FIG. 1c);

FIG. 2 illustrates a previously disclosed contoured passive radiator and the loudspeaker incorporating same;

FIG. 3 illustrates a thin loudspeaker system with a contoured passive radiator enclosure in accordance with an embodiment of the present disclosure;

FIGS. 4a-4d are a cross-sectional shapes of a transmission line;

FIG. 5a is a front view and FIG. 5b is bottom view of a thin loudspeaker system with a contoured passive radiator enclosure when used in a table stand 32″ LCD TV, in accordance with an embodiment of the present disclosure;

FIG. 6a is a back view, FIG. 6b is top view and FIG. 6c is a side view of the system of FIGS. 5a and 5b;

FIG. 7 is another side view of the system of FIGS. 5a and 5b placed with an elevated angle;

FIG. 8 is a frequency response comparison between a prior art loudspeaker using a 3 inch×4 inch oval loudspeaker and an embodiment of the presently disclosed system having a contoured passive radiator;

FIG. 9a is a front view, FIG. 9b is a top view and FIG. 9c is side view of a thin loudspeaker system with a contoured passive radiator enclosure, implemented in a hi-fi audio system, in accordance with an embodiment of the present disclosure;

FIGS. 10a, 10b, 10c and 10d illustrate a thin loudspeaker system with a contoured passive radiator enclosure, implemented in a car loudspeaker, the contoured passive radiator being placed at the bottom of the front seat, in accordance with an embodiment of the present disclosure;

FIGS. 11a, 11b and 11c illustrate a thin loudspeaker system with a contoured passive radiator enclosure, implemented in a car loudspeaker, the contoured passive radiator being placed at the back of front chair, in accordance with an embodiment of the present disclosure; and

FIG. 12 illustrates a thin loudspeaker system with a contoured passive radiator enclosure, implemented in a wall loudspeaker, the contoured passive radiator being placed inside the wall, in accordance with an embodiment of the present disclosure.

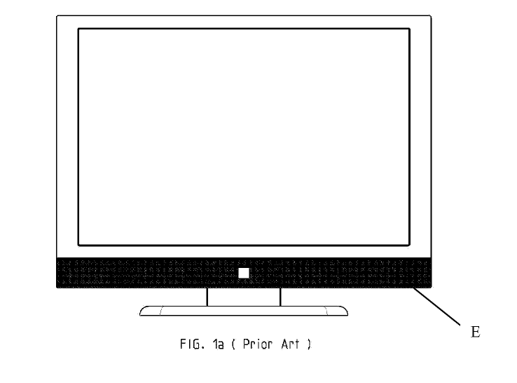

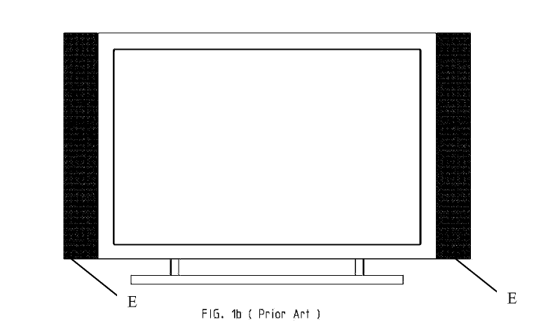

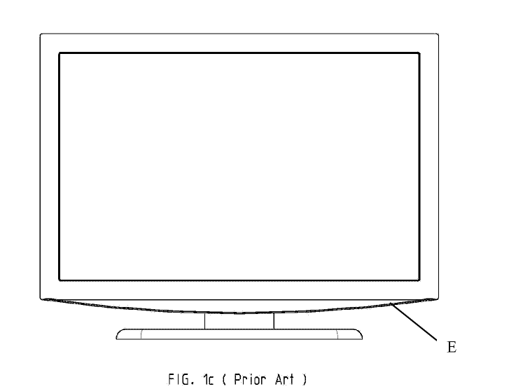

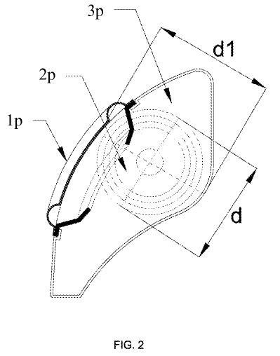

### DETAILED DESCRIPTION

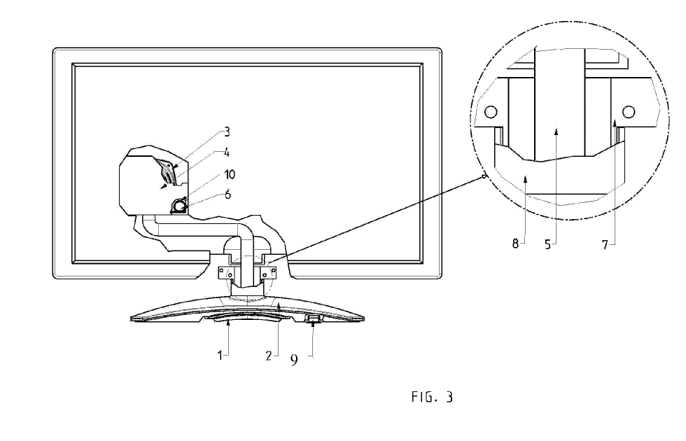

Reference is now made to FIG. 3, which shows an embodiment of a loudspeaker system with a contoured passive radiator enclosure, which is implemented in a main unit, such as a table stand 32″ LCD TV. The system has a contoured passive radiator enclosure 2 which may act as a TV stand. There is a contoured passive radiator diaphragm 1 in the contoured passive radiator enclosure 2, and the diaphragm 1 may be placed at the bottom of the stand. The radiator diaphragm 1 may have an arcuate contour which follows the contour of the contoured passive radiator enclosure 2. The passive radiator diaphragm 1 may have a supporting frame extending around it and a round edge. The diaphragm 1 may have a spider diaphragm, to permit compliance of the passive radiator diaphragm 1. The spider diaphragm and the passive radiator diaphragm 1 may be concentric, using a hollow structure, which may be made of an aluminum material, for example.

At the top side of the stand, there is a hollow structure 7 for supporting the LCD panel. The hollow structure may be, for example, made of a metal material such as an iron material for example, and may be covered with a plastic material 8, for example. Inside the hollow structure, there is a transmission line 5 that connects the passive radiator enclosure 2 to the loudspeaker enclosure 4. The loudspeaker enclosure 4 may have a loudspeaker driver installed in it. There may be a pair of voice coils that are synchronously winding and are connected with the left and right signal sources. At the bottom of the contoured passive radiator enclosure 2, there are holes that are closed with a cover 9. The cover 9 may be removed when the loudspeaker system is implemented in a wall mounted system. A low frequency loudspeaker 3 is placed in the loudspeaker enclosure 4. The loudspeaker 3 may be relatively thin. A short transmission line 6 connects to the back of the low frequency enclosure 4, and the short transmission line 6 may be closed with a back cover 10. The back cover 10 may be removed when the loudspeaker system is implemented in a wall mounted system. The contoured passive radiator enclosure 2 may allow the sound pressure level at low frequencies to be increased with less distortion, compared to a conventional loudspeaker.

This system may produce less distortion than a conventional bass reflex system, since this system does not produce the turbulent sound that is generated by the port of the bass reflex system radiating reflected sound from inside the enclosure. This system may allow the production of a high bass sound pressure level in a thin audio system, such as in a thin LCD TV, without producing sound distortion due to turbulent sound at the port.

Although the contoured passive radiator enclosure 2 is shown placed at the bottom of the system, the contoured passive radiator enclosure 2 may also be placed at the left and right sides of the system, or at any other suitable location. The main unit may also have an audio amplifier, and other electronics circuitry, such as a DVD and/or CD-ROM player. For a full range loudspeaker system, a mid-high loudspeaker with appropriate enclosure may be installed, either in the contoured passive radiator enclosure or in the main unit. With this system, the loudspeaker system of an audio hi-fi system may be as thin as possible depending on the thickness of the contoured passive radiator, and may be not only a flat surface but may be a contoured shape. This design may also affect the aesthetic design of the system, as it may be very flexible. This system may produce a higher sound pressure level at low frequencies and with less distortion.

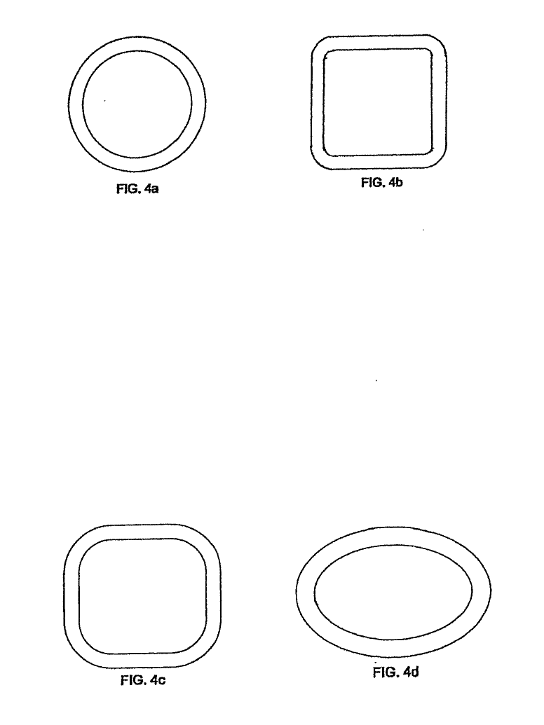

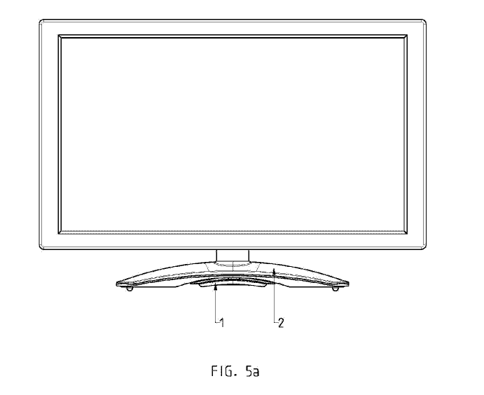

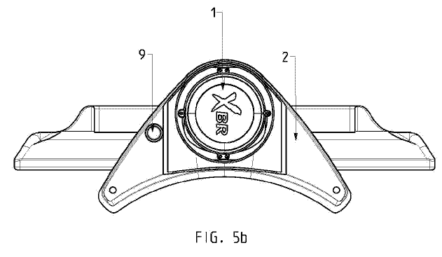

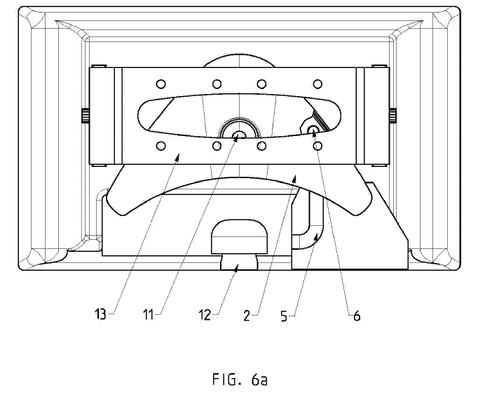

A variety of cross-sectional shapes for the transmission line 5 may be possible. The cross-sectional shapes of the transmission line 5 may be, for example, circular (FIG. 4a), rounded rectangular (FIG. 4b), ovular (FIG. 4c), elliptical (FIG. 4d), or any other suitable shape, as would be known to a person skilled in the art.

Reference is now made to FIGS. 5a and 5b, showing a front view and a bottom view, respectively, of an embodiment of the loudspeaker system implemented in a table stand 32″ LCD TV. There is a contoured passive radiator diaphragm 1 facing downwards. The contoured passive radiator diaphragm 1 may have a range of sizes, for example ranging from about 5 inches to about 10 inches, depending on the size of the table stand. In FIGS. 5a and 5b, for example, the diaphragm size is 6.5 inches. The bigger the size of diaphragm, typically the greater the air volume movement that may be achieved. With appropriate compliance and weight of the diaphragm, as would be known by a person skilled in the art, the sound pressure level (SPL) at low frequencies may increase significantly. There is also a hole cover 9 that may be removed for wall mounting purposes.

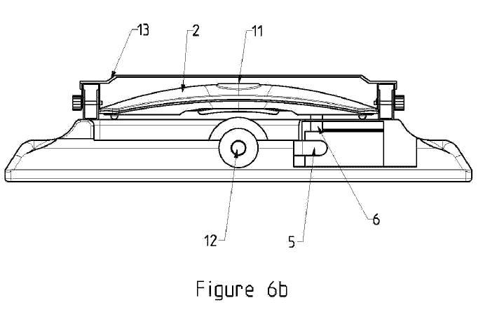

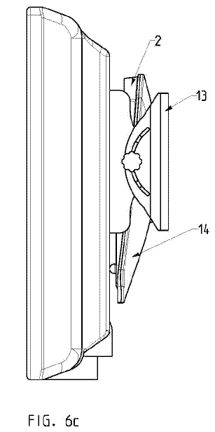

Reference is now made to FIGS. 6a and 6b, showing a back view and a bottom view, respectively, of an embodiment of the loudspeaker system implemented in a wall mounted LCD TV. The contoured passive radiator enclosure 2 that may be used as an LCD TV stand may be moved to the back side for a wall mounted TV. The hole at the upper side of the passive radiator enclosure 2 may be closed with a cover 11, while a cover at the bottom of the passive radiator enclosure may be removed. The end of the transmission line 5 that faces towards the bottom side may be closed with a cover 12, while the short transmission line 6 may have a cover that may be opened. The short transmission line 6 connects to the contoured passive radiator enclosure 2. There is a hanger 13 for mounting the LCD TV to the wall.

Reference is now made to FIG. 6c which shows a side view of an embodiment of the loudspeaker system for a wall mounted application. When the LCD TV is implemented as a wall mounted application, it typically has some space between the back cover and the wall, because usually an LCD TV has an elevation angle, especially when it hangs at the top of the wall, near the ceiling. This space typically is sufficient to place the contoured passive radiator enclosure 2 between the LCD TV and the hanger 13. The design of the top side of the passive radiator enclosure 2 has a convex surface 14 so there is typically enough space between the TV and the wall when the elevation angle is being adjusted.

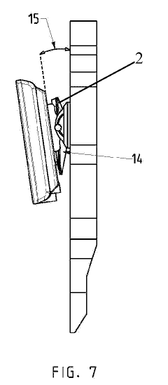

Reference is now made to FIG. 7 which shows a side view of an embodiment of the loudspeaker system in a wall mounted application. When the position of the LCD TV is rather near the ceiling, the LCD TV typically has an elevation angle 15. The top side of contoured passive radiator enclosure 2 has a convex surface 14. The shape of the convex surface 14 may be designed to allow enough space between the wall and the LCD cover even when there is no elevation angle between the LCD TV and the wall.

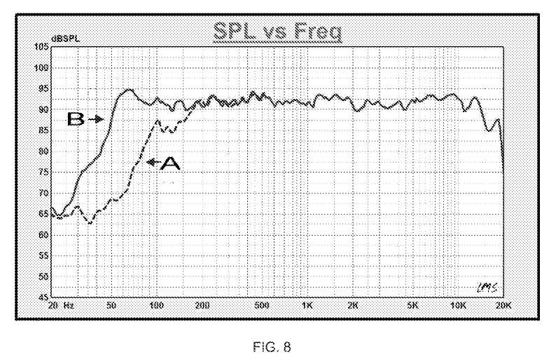

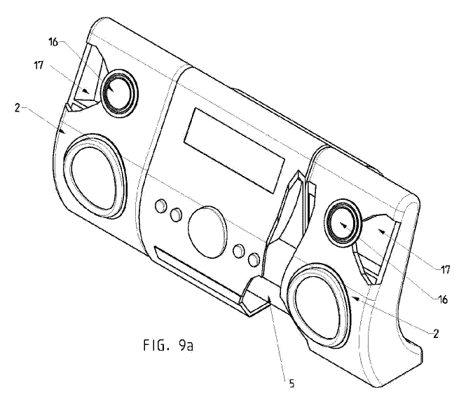

Reference is now made to FIG. 8, which illustrates a series of frequency response curves that compare the sound pressure level of a conventional loudspeaker using a 3 inch×5 inch oval loudspeaker (the data denoted by A) and an embodiment of the presently disclosed loudspeaker system using a separate contoured passive radiator enclosure (the data being denoted by B). As seen in the curves, from about 30 Hz until about 200 Hz, there is an increment sound pressure level up to about 22 dB at about 65 Hz for the present system with a contoured passive radiator as compared to the conventional loudspeaker.

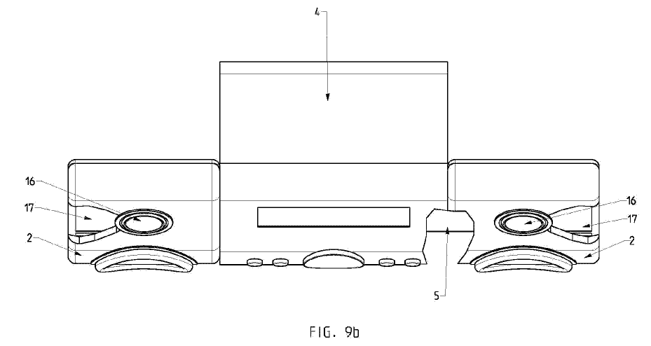

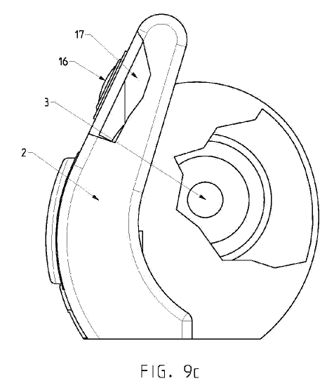

Reference is now made to FIGS. 9a, 9b and 9c, showing a front view, a top view and a side view, respectively, of an embodiment of the loudspeaker system implemented in an audio hi-fi system. There are a pair of contour passive radiator enclosures 2 at the left and right sides of the audio hi-fi main unit. At the top of each passive radiator enclosure 2, there is a separate mid-high frequency loudspeaker 16 mounted on an enclosure 17. The passive radiator enclosure 2 is connected to the low frequency loudspeaker enclosure 4 through a transmission line 5. The low frequency loudspeaker enclosure 4 may be placed at the main unit of the audio hi-fi system. Using this loudspeaker system, the audio hi-fi system may use a relatively thin (e.g., 2 cm) loudspeaker enclosure while still providing good deep bass sound quality and less distortion. Moreover, since there is an arcuate contour in a thin enclosure, the design and styling of the audio hi-fi system may be more flexible.

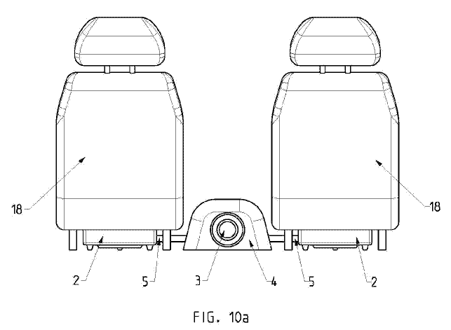

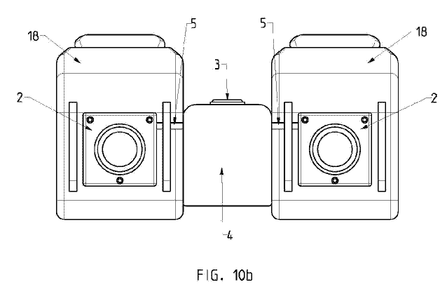

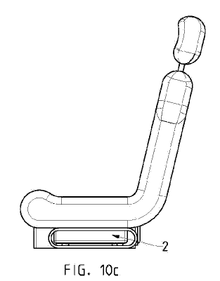

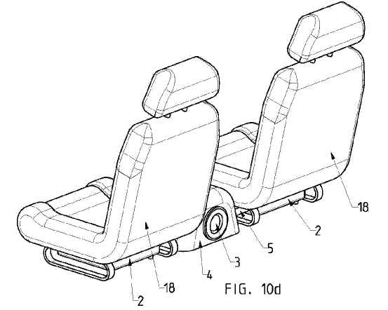

The loudspeaker system may be implemented in a car loudspeaker, for example as a thin sub-woofer system. Reference is now made to FIGS. 10a, 10b, 10c and 10d showing a back view, a bottom view, a side view and a perspective view, respectively, of an embodiment of the loudspeaker system implemented in a car. A pair of contoured passive radiator enclosures 2 may be placed at the bottom of each front chair 18. Each passive radiator enclosure 2 is connected to the loudspeaker enclosure 4 through a transmission line 5. The loudspeaker enclosure 4, which may house the electronic circuits for the system, may be placed between the front chairs 18. In this enclosure 4, there is installed at least one low frequency loudspeaker 3. This system may be used in cars with very limited space, for example city cars, and may allow the increase of the low frequency sound pressure level while limiting distortion for bass sound.

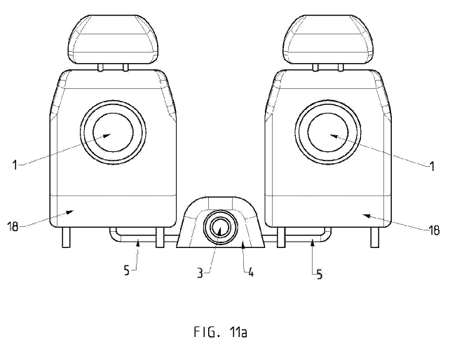

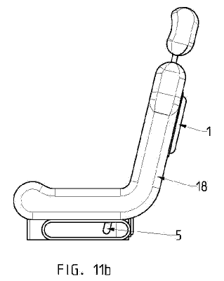

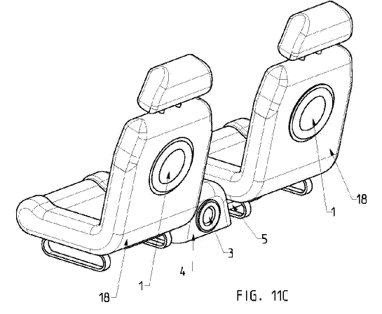

Reference is now made to FIGS. 11a, 11b and 11c, showing a back view, a side view and a perspective view, respectively, of an embodiment of the loudspeaker system implemented in a car loudspeaker application, where the contoured passive radiator enclosure (not shown) is placed at the back of each front chair 18. The enclosure may be covered with a chair cover so that it is not visible, while the sound and the vibration of the loudspeaker may be heard and felt by a passenger. The passive radiator enclosure is connected to the loudspeaker enclosure 4 through a transmission line 5. In this enclosure 4 is installed at least one low frequency loudspeaker 3. A contoured passive radiator diaphragm 1 is attached to the contoured passive radiator enclosure.

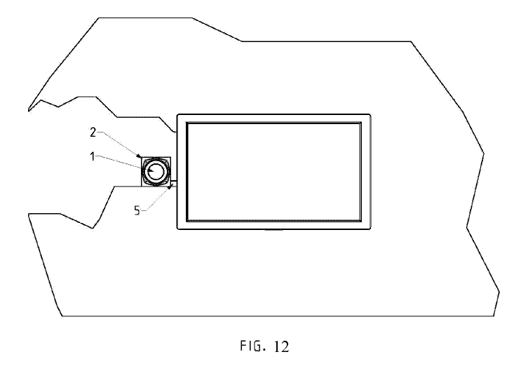

Reference is now made to FIG. 12, which shows an embodiment of the loudspeaker system implemented in a wall loudspeaker. The contoured passive radiator enclosure 2 may be placed inside the wall. A loudspeaker enclosure (not shown) placed in the LCD TV is connected to the contoured passive radiator through a transmission line 5. A contoured passive radiator diaphragm 1 is attached to the contoured passive radiator enclosure 2.

There is also provided a method for increasing the bass frequency sound pressure level using this system. By implementing the system with a contoured passive radiator enclosure as described above, the low frequency sound pressure level of a thin loudspeaker system may be improved.

Although embodiments of the disclosure have been described above, these are for the purpose of example and illustration only, and are not intended to be limiting. It will be apparent to those skilled in the art that numerous modifications may be made without departing from the spirit, nature and scope of the present disclosure. All references mentioned are hereby incorporated by reference in their entirety.

1. A thin loudspeaker system for audio-video equipment, comprising:
at least one loudspeaker enclosure having at least one loudspeaker driver placed inside a main unit;
at least one contoured passive radiator enclosure having at least one passive radiator diaphragm separate from the loudspeaker enclosure, outside the main unit; and
at least one transmission line for connecting the contoured passive radiator enclosure to the loudspeaker enclosure.

2. The loudspeaker system as set forth in claim 1, wherein the transmission line has a cross-sectional shape selected from the group consisting of: a circular shape, a rounded rectangular shape, an ovular shape, and an elliptical shape.

3. The loudspeaker system as set forth in claim 1, wherein the enclosure forms a support for a liquid crystal display (LCD) television (TV), the system comprising:
a thin enclosure having a convex shape, and having a top surface to serve as a TV stand support structure;
a contoured passive radiator connected at the bottom side of the enclosure;
a hollow structure connected to the top surface; and
at least one transmission line inside the hollow structure.

4. The loudspeaker system as set forth in claim 3, wherein the top surface is a thin metal surface.

5. The loudspeaker system as set forth in claim 3, wherein the hollow structure is made of an iron material and covered with a plastic material.

6. The loudspeaker system as set forth in claim 3, wherein the at least one transmission line is made of a plastic material.

7. A loudspeaker system for audio equipment comprising:
at least one loudspeaker enclosure having at least one loudspeaker driver placed inside a main unit;
a pair of thin contoured passive radiator enclosures each having a passive radiator diaphragm separate from a loudspeaker enclosure, the enclosures being located at the left and right sides of the main unit; and
a transmission line for connecting each contoured passive radiator enclosure to the loudspeaker enclosure.

8. The loudspeaker system as set forth in claim 7, wherein the transmission line has a cross-sectional shape selected from the group consisting of: a circular shape, a rounded rectangular shape, an ovular shape, and an elliptical shape.

9. The loudspeaker system as set forth in claim 7, wherein the thin contoured passive radiator enclosure has a mid-high frequency loudspeaker with a separate enclosure.

10. The loudspeaker system as set forth in claim 7, wherein the loudspeaker enclosure has at least one loudspeaker driver separate from electronic circuits and other electro-mechanical components in the main unit.

11. A loudspeaker system for car audio equipment comprising:
a low frequency loudspeaker enclosure having at least one loudspeaker driver, placed inside the main unit, located between front chairs of a car;
at least two contoured passive radiator enclosures; and
a transmission line that connects the loudspeaker enclosure to the at least two passive radiator enclosures.

12. The loudspeaker system as set forth in claim 11, wherein the at least two contoured passive radiator enclosures are placed at the bottom of the front chairs.

13. The loudspeaker system as set forth in claim 11, wherein the at least two contoured passive radiator enclosures are placed at the back of the front chairs.

14. A method of increasing the bass frequency sound pressure level of a thin loudspeaker system, comprising:
providing at least one loudspeaker enclosure having at least one loudspeaker driver mounted therein, the loudspeaker enclosure being inside a main unit;
providing at least one contoured passive radiator enclosure having at least one passive radiator diaphragm separate from the loudspeaker enclosure, outside the main unit;
providing at least one transmission line for mounting the passive radiator enclosure outside the main unit; and
passing a bass signal through the loudspeaker driver whereby the sound pressure level of the output of the loudspeaker driver is increased.
